(19) United States
(12) Patent Application Publication
(10) Pub. No.: US 2024/0354145 A1
(43) Pub. Date: Oct. 24, 2024

(54) DRIVER GENERATION DEVICE AND DRIVER GENERATION METHOD

(71) Applicant: Toshiba Tec Kabushiki Kaisha, Tokyo (JP)

(72) Inventors: Yoshihiro KOMATSUBARA, Mishima (JP); Yasuhiro INAGAKI, Mishima (JP)

(73) Assignee: Toshiba Tec Kabushiki Kaisha, Tokyo (JP)

(21) Appl. No.: 18/642,106

(22) Filed: Apr. 22, 2024

(30) Foreign Application Priority Data
Apr. 24, 2023 (JP) 2023-071138

(51) Int. Cl. G06F 9/455

(52) U.S. Cl. CPC G06F 9/45558; G06F 2009/45579

(57) ABSTRACT

A driver generation device includes a processor and a storage device. The storage device stores an application source for a Linux driver, a container including a compiler that compiles the application source, container virtualization software that manages the container, and a patch for the compiler. The storage device stores a driver generation program that causes the computer to implement a function of determining whether the patch is required during execution of compilation, during starting of the container, a function of mounting the patch into the container if it is determined that the patch is required, a function of mounting the application source into the container, and a function of compiling the application source to generate a Linux driver.

### CROSS-REFERENCE TO RELATED APPLICATION

This application is based upon and claims the benefit of priority from Japanese Patent Application No. 2023-071138, filed on Apr. 24, 2023, the entire contents of which are incorporated herein by reference.

### FIELD Embodiments described herein relate generally to a driver generation device and a driver generation method.

### BACKGROUND

A technology that uses container virtualization software represented by “Docker (registered trademark)” or the like to place a source code in a container, which is a virtual environment that does not depend on software of a host PC, which is a development machine, by mounting a directory on the host PC into the container, and realizes a compilation environment in which the source code is compiled within the container is known.

### DESCRIPTION OF THE DRAWINGS

FIG. 1 is a diagram illustrating a hardware configuration of a driver generation device according to at least one embodiment;

FIG. 2 is a diagram schematically illustrating a functional configuration of the driver generation device;

FIG. 3 is a diagram illustrating a configuration example of a file system patch; and

FIG. 4 is a flowchart illustrating a flow of processing an operation of the driver generation device.

### DETAILED DESCRIPTION

Some software requires a unique environment, such as other proprietary libraries or a plurality of source codes, to be placed in an appropriate path during execution of compilation. For example, a Linux driver that requires a Linux (registered trademark) kernel source corresponds to this software. As such, if preliminary preparation occurs in the development, the source code cannot be compiled by simply placing the source code in the container.

At least one embodiment provides a driver generation device capable of compiling a source code that requires a unique environment during execution of compilation in a container.

In general, according to at least one embodiment, there is provided a driver generation device that includes a computer including a processor and a storage device. The storage device stores an application source for a Linux driver, a container including a cross compiler that compiles the application source, container virtualization software that manages the container, and a file system patch for the cross compiler. The storage device stores a driver generation program that causes the computer to implement a function of determining whether the file system patch is required during execution of compilation by the cross compiler, during starting of the container by the container virtualization software, a function of mounting (inserting) the file system patch into the container if it is determined that the file system patch is required, a function of mounting the application source into the container, and a function of compiling the application source to generate a Linux driver.

Hereinafter, a driver generation device according to at least one embodiment will be described with reference to the drawings.

### Hardware Configuration

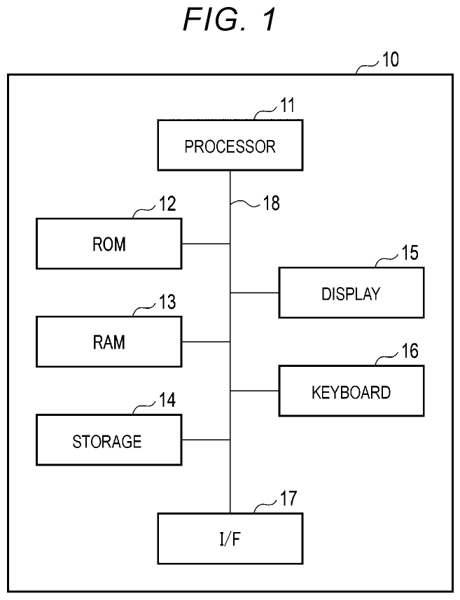

First, with reference to FIG. 1, a hardware configuration of a driver generation device 10 according to at least one embodiment will be described. FIG. 1 is a diagram illustrating the hardware configuration of the driver generation device 10. The driver generation device 10 is configured with a computer.

As illustrated in FIG. 1, the driver generation device 10 includes a processor 11, a read only memory (ROM) 12, a random access memory (RAM) 13, a storage 14, a display 15, a keyboard 16, and an interface (I/F) 17. In addition to these components, the driver generation device 10 may include other peripheral devices.

The processor 11, the ROM 12, the RAM 13, the storage 14, the display 15, the keyboard 16, and the interface 17 are electrically connected to each other via a bus 18, and transmit and receive data to and from each other via the bus 18.

The processor 11 is hardware that executes a program and processes data. The processor 11 is configured with a general-purpose hardware processor including, for example, a central processing unit (CPU) and a graphical processing unit (GPU). The processor 11 controls each of the ROM 12, the RAM 13, the storage 14, the display 15, the keyboard 16, and the interface 17.

The ROM 12 and RAM 13 configure a main storage device. The ROM 12 is a non-volatile memory. The RAM 13 is volatile memory.

The ROM 12 stores a startup program required for starting the driver generation device 10. The processor 11 starts the driver generation device 10 by executing the startup program within the ROM 12. The ROM 12 is configured with, for example, an erasable programmable read only memory (EPROM), and stores various settings during startup in addition to the startup program.

The RAM 13 temporarily stores a program required for the processor 11 to perform various functions and data required for executing the programs.

The storage 14 is an auxiliary storage device that non-temporarily stores data. The storage 14 is configured with a non-volatile memory such as a hard disk drive (HDD) or a solid state drive (SSD). The storage 14 non-temporarily stores the program executed by the processor 11 and data required for executing the program. The processor 11 reads the program and data within the storage 14 into the RAM 13, and executes various functions by executing the program.

The display 15 is an output device (e.g., an output interface) that outputs data. The display 15 presents various information to the user.

The keyboard 16 is an input device that receives data. The keyboard 16 receives an instruction to be executed by the processor 11, data to be stored in the storage 14, and the like.

The interface 17 is connected to an external device and enables data input and output to and from the external device. The external device may include an input device such as a mouse and a receiving device, an output device such as a transmitting device (transmitter), and an input/output device such as a disk drive.

### Functional Configuration

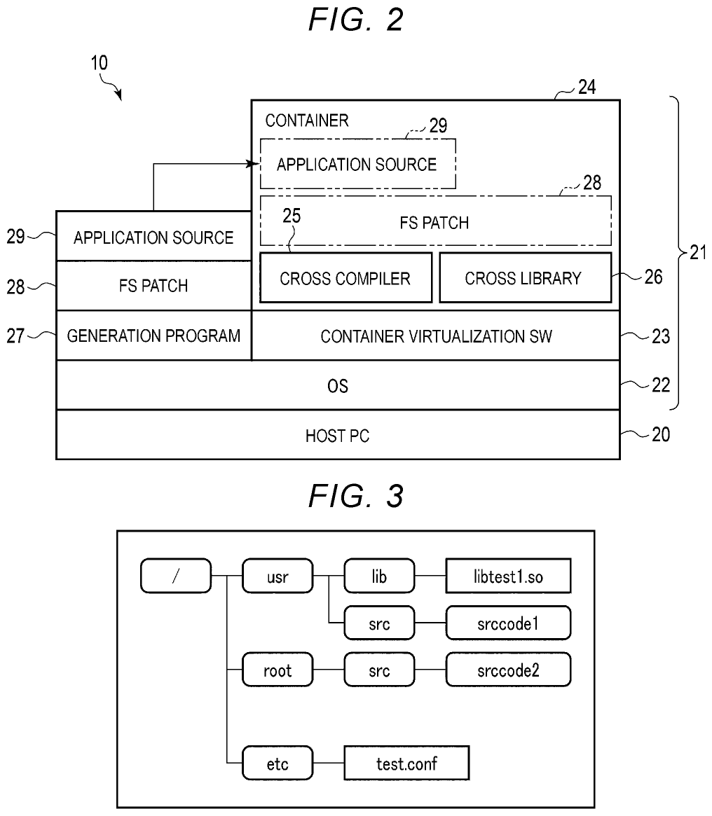

Next, with reference to FIG. 2, a functional configuration of the driver generation device 10 will be described. FIG. 2 is a diagram schematically illustrating the functional configuration of the driver generation device 10.

As illustrated in FIG. 2, the driver generation device 10 includes a host PC 20 and a software configuration 21 installed in the host PC 20. The software configuration 21 is stored in the storage 14, and is read into the RAM 13 during starting of the driver generation device 10.

The software configuration 21 includes an OS 22, container virtualization software 23, a container 24, a driver generation program 27, a file system patch 28, and an application source 29. The host PC 20 is a physical computer that executes the container virtualization software 23.

The container virtualization software 23 is a platform that realizes a container-type virtual environment. The container virtualization software 23 provides an execution environment for managing the container 24. Management of the container 24 includes starting the container 24, executing an application within the container 24, and stopping and removing the container 24.

The container 24 is formed by mounting a container image onto the container virtualization software 23. The container 24 provides an application execution environment independent of the platform. In at least one embodiment, the container 24 provides a compilation execution environment for compiling the application source 29.

The container 24 includes a cross compiler 25 and a cross library 26. The container 24 operates using a kernel of the OS 22. For example, the container virtualization software 23 is a Docker engine, and the container 24 is a Docker container.

The application source 29 is the source code of an application that requires the proprietary library during compilation (e.g., the application utilizes the library during the compilation process). In other words, the application source 29 is a source code of an application that cannot be built simply by placing the application in the container 24. For example, the application is a Linux driver that requires a Linux kernel source. The Linux driver is, for example, one or more of a driver for a multi-function peripheral (MFP), a barcode printer (BCP), a point of sale (POS) system, a POS peripheral device, and the like.

The file system patch 28 is a set of directory structures and files required by the cross compiler during execution of compilation of the application source 29. A configuration example of the file system patch 28 is illustrated in FIG. 3. In FIG. 3, libtest.so under a lib directory under a usr directory, srccode1 under a src directory under the usr directory, srccode2 under a src directory under a root directory, and test.conf under an etc directory correspond to the file system patch 28.

The libtest.so is a shared object file required by the cross compiler 25 during compilation of the application source 29. For example, libtest.so is a library that is linked during compilation of the application source 29.

For example, test.conf is a configuration file for environment variables, options, and the like required by the cross compiler 25 during compilation of the application source 29.

For example, srccode1 and srccode2 are header files required during compilation of the application source 29. The header file is a file for declaring a function, a constant, a structure, and the like.

The file system patch 28 may be combined into one file as tar.gz, for example.

### Operation

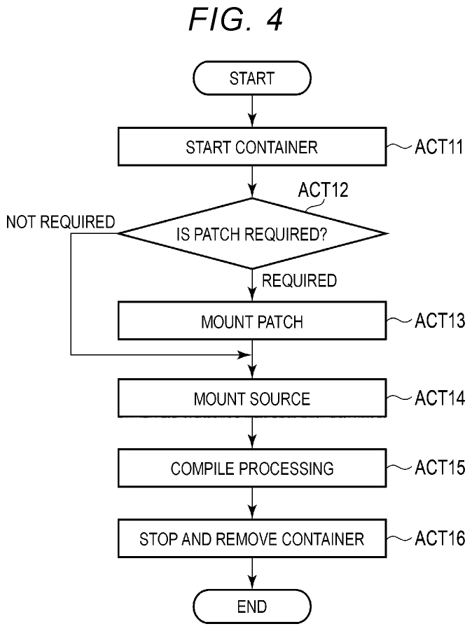

The operation of the driver generation device 10 will be described below with reference to FIG. 4. The driver generation device 10 operates to generate an application, such as the Linux driver by compiling the application source 29 using a container technology. FIG. 4 is a flowchart illustrating a flow of processing of the operation of the driver generation device 10.

The operation of the driver generation device 10 is performed by the processor 11 executing the driver generation program 27 under the control of the OS 22 and by controlling the container virtualization software 23 according to the driver generation program 27. From another point of view, the operation of the driver generating device 10 is performed by the driver generating program 27 controlling the container 24 through the container virtualization software 23. In the following, for convenience, the driver generation program 27 and the container virtualization software 23 will be described as operating entities. The driver generation program 27 and the container virtualization software 23 are assumed to be started.

In ACT 11, the driver generation program 27 causes the container virtualization software 23 to start the container 24. In this case, the driver generation program 27 receives a startup option for the container 24 designated by a user.

In ACT 12, the driver generation program 27 determines whether a patch file is required for compiling the application source 29 by the cross compiler 25 within the container 24. If it is determined that the patch file is required, the process proceeds to processing of ACT 13, and if it is determined that the patch file is not required, the process skips the processing of ACT 13 and proceeds to processing of ACT 14. Whether the patch file is required is designated by the user as the startup option for the container 24.

In ACT 13, the driver generation program 27 causes the container virtualization software 23 to mount the file system patch 28 into the container 24. In this case, the contents of the file system patch 28 are loaded into the container 24, as illustrated in FIG. 3, for example.

In ACT 14, the driver generation program 27 causes the container virtualization software 23 to mount the application source 29 into the container 24. With this configuration, the application source 29 is shared between the host PC 20 and the container 24. Therefore, the processing for the application source 29 within the container 24 is also reflected on the application source 29 on the host PC 20.

In ACT 15, the driver generation program 27 causes the container virtualization software 23 to allow the cross compiler 25 to compile the driver source 29 within the container 24. As a result, a Linux driver is generated within the container 24 and on the host PC 20.

In ACT 16, the driver generation program 27 causes the container virtualization software 23 to stop and remove the container 24.

Through the process described above, the operation of the driver generation device (generator) 10, that is, the process of compiling the driver source 29 using the container 24 and generating the Linux driver is completed.

### Driver Generation Program

As can be seen from the above description, the driver generation program 27 causes the host PC 20 to implement a function of determining whether the file system patch 28 is required during execution of compilation by the cross compiler 25, during starting of the container 24 by the container virtualization software 23, a function of mounting the file system patch 28 into the container if it is determined that the file system patch 28 is required, a function of mounting the application source 29 into the container 24, and a function of compiling the application source 29 to generate a Linux driver.

From another point of view, the driver generation program 27 determines whether the file system patch 28 is required during execution of compilation by the cross compiler 25, during starting of the container 24 by the container virtualization software 23, causes the container virtualization software 23 to mount the file system patch 28 into the container 24 if it is determined that the file system patch 28 is required, then causes the container virtualization software 23 to mount the application source 29 into the container 24, and then causes the container virtualization software 23 to allow the cross compiler 25 to compile the application source to generate a Linux driver.

### Effect

As can be seen from the above description, according to at least one embodiment, when compiling the application source 29 that requires a special directory structure or unique file during execution of compilation, the file system patch 28 having the special directory structure and unique file is mounted into the container 24 during starting of the container 24. Therefore, the application source 29 that requires the special directory structure or unique file during execution of compilation can be compiled. The file system patch 28 that is once mounted can be used for the second and subsequent compilations, and thus the effort and time for placing the required directory structure and unique file for each compilation can be reduced. Source code management becomes easier by combining the file system patches into a single file as tar.gz.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A driver generation device comprising:
a computer including:
a processor, and
a storage device configured to store:
an application source for a Linux driver,
a container including a cross compiler configured to compile the application source,
container virtualization software configured to manage the container, and
a file system patch for the cross compiler,
the storage device being configured to store a driver generation program that causes the computer to implement:
a function of determining whether the file system patch is required during execution of compilation by the cross compiler, during starting of the container by the container virtualization software,
a function of inserting the file system patch into the container when it is determined that the file system patch is required,
a function of inserting the application source into the container, and
a function of compiling the application source to generate a Linux driver.

2. The device according to claim 1, wherein
the file system patch includes a set of directories and files required by the cross compiler during execution of compilation of the application source.

3. A driver generation device comprising:
a computer; and
a software configuration installed in the computer, the software configuration including:
an application source for a Linux driver,
a container including a cross compiler configured to compile the application source,
container virtualization software configured to manage the container,
a file system patch for the cross compiler, and
a driver generation program configured to control the container virtualization software, and
the driver generation program being configured to:
determine whether the file system patch is required during execution of compilation by the cross compiler, during starting of container by the container the virtualization software,
cause the container virtualization software to insert the file system patch into the container when it is determined that the file system patch is required,
cause the container virtualization software to insert the application source into the container, and
cause the container virtualization software to allow the cross compiler to compile the application source to generate the Linux driver.

4. A driver generation method comprising:
causing a computer of a driver generation device, the computer including: a processor, and a storage device configured to store an application source for a Linux driver, a container including a cross compiler configured to compile the application source, container virtualization software configured to manage the container, and a file system patch for the cross compiler, to implement:
determining whether the file system patch is required during execution of compilation by the cross compiler, during starting of the container by the container virtualization software,
inserting the file system patch into the container when it is determined that the file system patch is required,
inserting the application source into the container, and
compiling the application source to generate a Linux driver.

5. A driver generation method comprising:
causing a computer of a driver generation device, the computer including an application source for a Linux driver, a container including a cross compiler configured to compile the application source, container virtualization software configured to manage the container, a file system patch for the cross compiler, and a driver generation program configured to control the container virtualization software, to carry out operations comprising:
determining whether the file system patch is required during execution of compilation by the cross compiler, during starting of the container by the container virtualization software,
allowing the container virtualization software to insert the file system patch into the container when it is determined that the file system patch is required,
allowing the container virtualization software to insert the application source into the container, and
allowing the container virtualization software to operate such that the cross compiler is caused to compile the application source to generate the Linux driver.

6. The device according to claim 1, further comprising an output interface configured to output data.

7. The device according to claim 6, wherein the output interface comprises a display.

8. The device according to claim 2, further comprising an output interface configured to output data.

9. The device according to claim 8, wherein the output interface comprises a display.

10. The driver generation device according to claim 3, further comprising an output interface configured to output data.

11. The driver generation device according to claim 10, wherein the output interface comprises a display.

12. The method according to claim 4, further comprising outputting output data.

13. The method according to claim 12, further comprising displaying the output data.

14. The method according to claim 5, further comprising outputting output data.

15. The method according to claim 14, further comprising displaying the output data.

16. The method of claim 5, wherein the application source includes source code of an application that utilizes a library during compilation.
